(19) United States
(12) Patent Application Publication
(10) Pub. No.: US 2016/0132588 A1
(43) Pub. Date: May 12, 2016

(54) ASSOCIATING IDENTIFIERS TO PARTICIPANTS

(71) Applicant: TRM TRADING (UK) LIMITED, London (GB)

(72) Inventor: Francis Duncan, London (GB)

(21) Appl. No.: 14/893,496

(22) PCT Filed: May 23, 2014
(86) PCT No.: PCT/EP2014/060710

§ 371 Date: Nov. 23, 2015

(30) Foreign Application Priority Data
May 24, 2013 (GB) 1309425.5

(51) Int. Cl. G06F 17/30; G06F 21/31; G06K 7/10; G06K 19/077; G06K 19/06; G06K 7/14

(52) U.S. Cl. CPC G06F 17/30604; G06K 19/06037; G06K 7/1404; G06K 7/10009; G06K 19/07762; G06F 17/30879; G06F 21/31

(57) ABSTRACT

A computer system for associating identifiers to identified participants, the system comprising: a computer terminal having access to a record holding participant data for an event at an event location, the computer terminal comprising a processor; a first input means for receiving a participant identifier at the event location, the participant identifier generated for and unique to the participant and associated with participant data in the record, the processor configured to recall from the record participant data associated with the participant identifier; and a second input means for receiving a further unique identifier, the processor configured to transmit to the record the further unique identifier for association with the participant data in the record.

### FIELD

The present invention relates to the field of event management, and in particular to allocating unique identifiers to participants of an event and associating the unique identifiers with one or more further unique identifiers.

### BACKGROUND

At an event, such as a running race, it is often desirable to associate specific devices or items with individual participants of the event. One example of an event at which it is desirable to associate an item with a participant is a large-scale athletic event, such as a marathon or triathlon. At these events it is increasingly common for a participant to be allocated a wearable tag that uniquely identifies them, such as an RFID tag or chip, which is used to measure the time taken for the participant to complete the event.

A common problem faced by event organisers is the time and effort-intensive process of allocating the devices and items to each participant. In a marathon, for example, current processes involve the event organisers allocating each participant a unique identifier and associating that unique identifier with an item (such as an RFID tag or bib number) several days in advance of the event. Each item must then be handed to the correct participant before the start of the event, either by posting the item as part of a pre-event pack to the participant or by having collection events where each participant must collect their items individually, such as at Expos often found at major running events.

It is an aim of the present invention to improve the efficiency of allocating unique identifiers to participants of an event and associating the unique identifiers with specific devices and items.

### SUMMARY

According to one aspect of the present disclosure there is provided a computer system for associating identifiers to identified participants, the system comprising: a computer terminal having access to a record holding participant data for an event at an event location, the computer terminal comprising a processor; a first input means for receiving a participant identifier at the event location, the participant identifier generated for and unique to the participant and associated with participant data in the record, the processor configured to recall from the record participant data associated with the participant identifier; and a second input means for receiving a further unique identifier, the processor configured to transmit to the record the further unique identifier for association with the participant data in the record.

The computer terminal may comprise a display for displaying user data to a terminal operator for authenticating identity of the participant.

The computer terminal may comprise a network interface for connection to a server. The computer system could comprise a server connected to the network interface and configured to receive the participant identifier and to transmit the participant data to the computer terminal.

The server may be configured to receive the further unique identifier and associate said further unique identifier with the participant data in the record.

The computer system could comprise a participant terminal having a network interface for connection to the server and arranged: to receive participant data from a participant, transmit the participant data to the server and to receive a unique participant identifier based on the participant data.

The unique participant identifier could be in the form of a code, Quick response code, barcode or data string. The first input means could comprise a barcode reader or QR reader. The second input means could comprise an RFID reader, GPS reader, barcode reader or QR reader.

The further unique identifier may comprise a device identifier.

The device may comprise an RFID tag.

The further unique identifier may comprise a participant bib number.

According to a second aspect of the present disclosure there is provided a competitive event tag allocation apparatus comprising a computer system, wherein the computer system could be any computer system previously described; a plurality of physical tags to be worn by participants in the event, each tag having a unique device identifier, wherein a tag is provided to a participant when its device identifier has been associated with the participant data. The tags could be RFID tags.

The competitive event tag allocation apparatus could comprise multiple computer terminals at one or more locations at an event venue.

According to a third aspect of the present disclosure there is provided a vendor apparatus comprising: a computer system, wherein the computer system could be any computer system previously described; and a plurality of vendor products each having a unique device identifier, wherein a vendor product is provided to a participant when its device identifier has been associated with the participant data. Each vendor product may be marked with its device identifier for automated receipt by the second input means.

According to a fourth aspect of the present invention there is provided an event server comprising: a processor; a memory holding a plurality of participant records, the records comprising participant data for each participant; an interface for connecting the server to at least one participant terminal and a computer terminal, the processor configured to: receive a participant identifier generated for and unique to a participant and transmit participant data associated with the participant identifier; and receive a further unique identifier and associate the further unique identifier with the participant data in the record.

The further unique identifier may comprise a device identifier.

The device may comprise an RFID tag.

### BRIEF DESCRIPTIONS OF THE DRAWINGS

The present disclosure will now be described by way of reference to the following drawings. In the drawings:

FIG. 1 is a schematic diagram of a known process for allocating unique identifiers to participants of an event.

FIG. 2 is a schematic diagram of a database for storing participant details.

FIG. 3 is a schematic diagram of a system for registering for an event and for associating unique identifiers to participants at the event.

FIG. 4 is a flow chart illustrating the steps of a participant registering for an event and being associated unique identifier at the event.

FIG. 5 is a schematic diagram of a participant profile database and database of unique identifiers during the association of a unique identifier to a participant of an event.

FIG. 6 is a flow chart of a participant purchasing merchandise from a vendor.

FIG. 7 is a schematic diagram of a database for associating equipment to suppliers.

### DETAILED DESCRIPTION

Below follows a definition of terms as used herein to describe the embodiments of the present disclosure by way of non-limiting example.

Participant: A customer, volunteer, guest, marketer, prospective customer, sales representative, event staff

Event: An occasion managed by an event organiser for participants.

Participant unique identifier: A unique code associated to each and only one participant.

Participant profile: A profile containing details of a participant such as, for example, first name, last name, email address, phone numbers etc. The event organiser can specify the minimum amount of data a prospective participant is required to enter into the participant profile in order to join an event. The participant may specify the data the event organiser can determine from their profile.

Unique identifiers: These can be any unique devices, personal attributes, codes or strings of information, which are unique at least to an event. Unique identifiers can be used to identify people, objects, accounts and media with which they have been associated. Unique identifiers could be, but are not limited to: biometric data of a person (for example, finger prints, palm scans, facial recognition, voice recognition, iris recognition etc.), an RFID tag, quick response (QR) code, a barcode, a mobile phone, a GPS tag, a MAC address, an IP address, a bib number etc.

Merchandise: Any product for sale at an event which may or may not be marked with means for automating its identity, such as a barcode, QR code, RFID tag etc.

The present disclosure describes an apparatus and method for allocating unique identifiers to participants of an event and for associating the unique identifiers with specific devices and items without the need to perform this association substantially in advance of the event. This results in a less laborious process for event organisers as well as benefiting the participants of the event through reduced entry time and an enhanced event experience brought about via additional unique identifiers that can be associated to them during the event, as will be explained below.

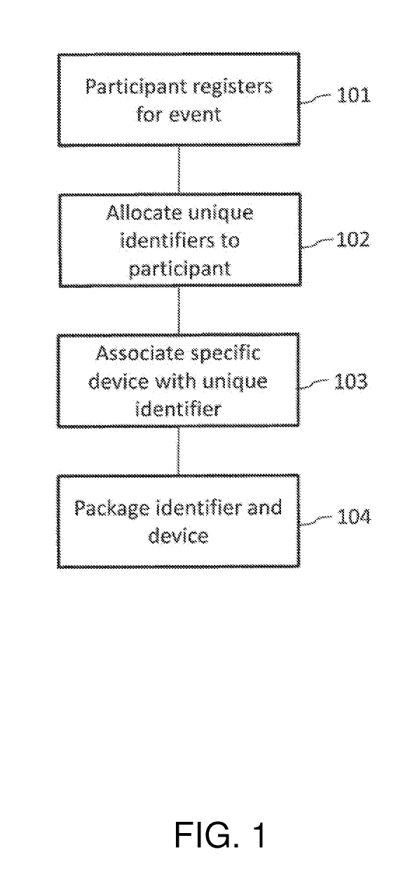

FIG. 1 shows a flowchart illustrating the known method of allocating a unique identifier to a participant of an event and associating that unique identifier with a specific device. For the purposes of illustration only, the event chosen is a marathon.

At step 101 a participant registers for the marathon. Typically, the registration process would be done online. During registration the participant will be required to enter personal details such as their name, email address, contact number and so on. When the participant registers for an event a profile is created for that participant.

At step 102 an event organiser will allocate to each registered participant a unique identifier that is associated with their profile, such as a bib number. This process needs to be repeated for each registered participant and stored, for example in a database. If it is desired to associate a further unique identifier to each participant, such as an RFID tag to measure the participant's time to run the marathon, then this is also done at this stage.

In order to associate the RFID tag with a particular participant, each tag will need to be programmed so that it is associated with the correct participant in the database. This could involve reading the data stored in the signal emitted by the tag, such as an Electronic Program Code, and then associating that data with a participant by entering the data into the relevant section of the database. Alternatively, the RFID tag may have a unique code printed on the tag that can be entered into the database.

Once the RFID tag and bib number has been associated with a participant it is necessary to package these identifiers, either for posting to the participant or for collection at the event. This is shown in step 103. In practice this requires the event organiser to place the correct RFID tag and associated bib number into an envelope and then correctly label the envelope with the participant's name. In the event that the envelopes are collected by the participant at the event, then the envelopes will also typically be required to be placed in alphabetical order.

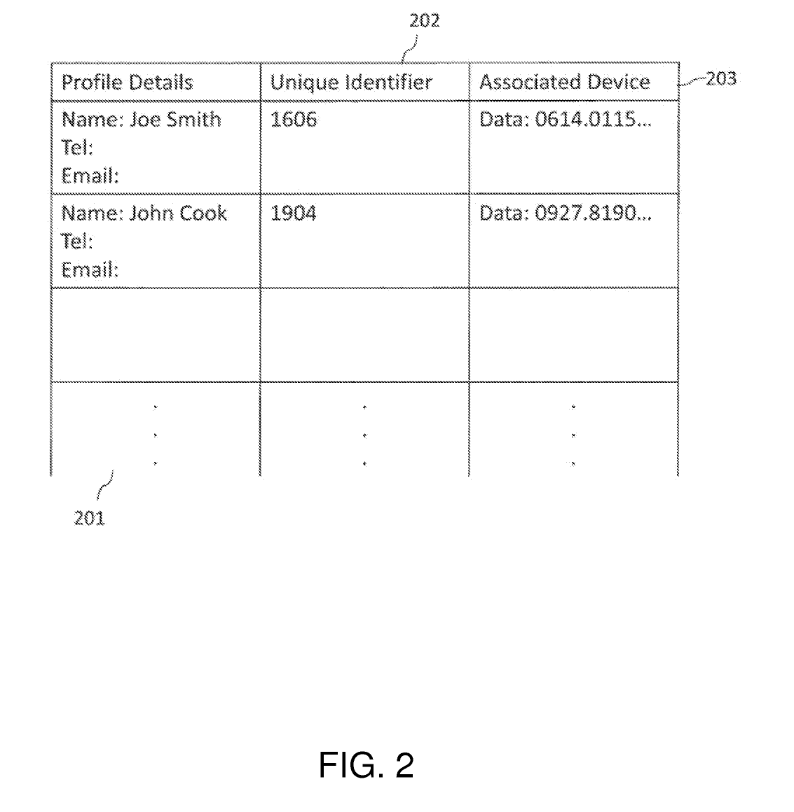

FIG. 2 shows a schematic diagram of the database as described with reference to FIG. 1. Column 201 contains the profile details of each registered participant. Column 202 contains the each participant's unique identifier as entered by the event organiser and column 203 contains data, which identifies each device associated with a particular participant. In the example that the associated device is an RFID tag, this data could be an Electronic Program Code or a code printed onto the tag.

As can be appreciated, the method described above is labour intensive. In addition, since each tag and bib number needs to be manually entered into the database, as well as then packaged, there is a large scope for error such as associating a tag with the wrong participant or placing the wrong bib number in a participant's envelope.

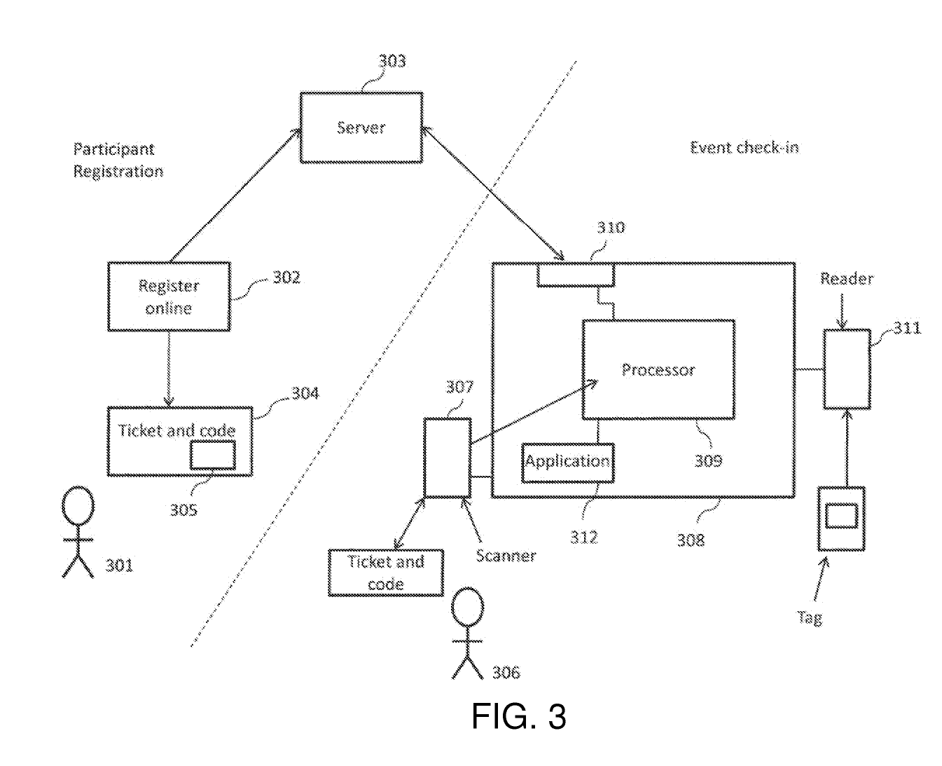

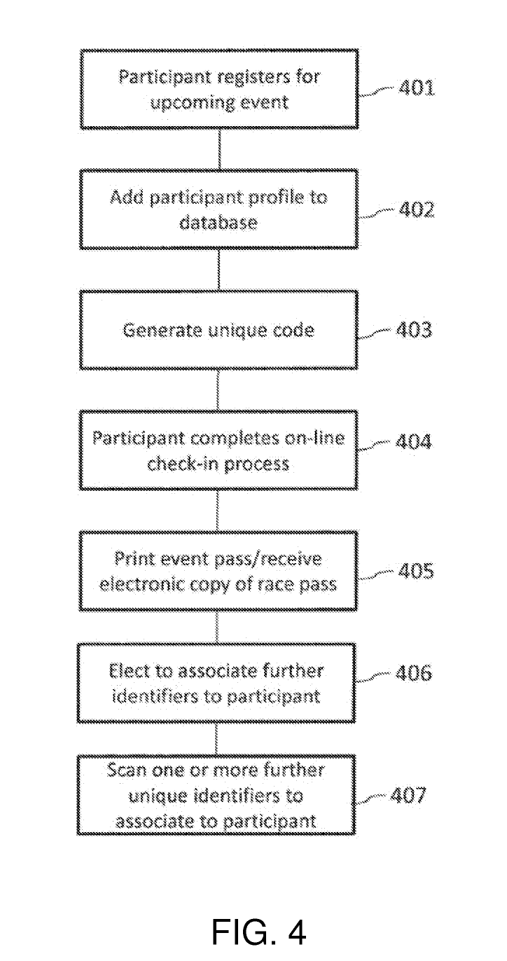

FIG. 3 shows a system for issuing unique identifiers to a participant according to the present disclosure and FIG. 4 is a flow chart in which the steps for issuing the unique identifiers are illustrated. For the purposes of illustration FIGS. 3 and 4 will be described with reference to the event being a running race, such as a marathon.

Below is a description of the components of the system of FIG. 3 which is used to describe the present disclosure by way of non-limiting example.

Participant database: A database of all the participants that have undertaken registration for an event. An event organiser will typically create an event and may advertise the event. Participants will then register for that event and a list of the participants that have registered will be available to the event organiser.

Participant profile database: When a participant registers for an event a profile is created for that participant where a prospective participant can enter details as specified by the event organiser as described above. On creation of each profile a unique code is allocated to each participant which serves to uniquely identify that participant. The unique code could be the unique identifier or the code is mapped from a unique identifier such as an RFID tag, QR code or barcode.

Race pass issuance: Participants may be required to complete an online check-in for their forthcoming event and print a race pass. The race pass may include a waiver and/ or terms and conditions of the event organiser that the participant must sign and agree to. Each printed race pass will display their unique identifier, such as a QR code. Each participant is required to bring their race pass to the race.

Event check-in: When the participant arrives at their event, they present their race pass to the event organiser's staff (referred to hereafter as event staff). The event staff scan/read the unique identifier on the race pass to deliver details of the participant's profile on a display screen. At this stage, the event staff can elect to associate additional unique identifiers to the participant, such as an RFID tag and bib number.

Database of unique identifiers: Each unique identifier could have a separate table in a database. So for example a table for RFID tags, a table for Bar codes, and table for fingerprints etc. could be stored in a single database.

Initially a prospective participant 301 will need to register for an upcoming event. Typically this is performed via an online registration but alternatively could be via the telephone or by filling out a registration form. If registering for an event online, the participant will register via a device 302 capable of connecting to the internet, such as a mobile phone, tablet or computer. When the participant 302 registers for an upcoming event a profile will be created containing their details, for example first and last name, email address, phone number etc. The participant profile is stored as participant data in a profile database located at a server 303. This is process is shown in steps 401 and 402 of FIG. 4.

The amount of data the participant is required to enter is implementation specific, for example certain events may require proof of age, or place of work if the event is a trade fair. The event organiser may wish to specify a mandatory amount of data that each participant is to provide in order to join the event.

Upon the creation of each participant profile, a unique code is generated, i.e. each profile has an associated unique code to identify the participant (step 403). The code could be capable of being embedded into a suitable form of unique identifier such as a QR code or barcode. The unique code is then stored in a database of unique identifiers stored at the server 303. The database of unique identifiers may comprise a table for each type of unique identifier, for example a table for QR codes, a table for RFID tags etc. Each table could also contain each participant profile to allow the association between participant and unique identifier. Alternatively, to reduce memory requirements each table may only contain entries for the unique identifier but each entry is mapped to a relevant entry in the participant profile database to associate a unique identifier to a participant.

Prior to the event, the participant 301 completes an online check-in process (step 404). Following completion of the online check-in, the participant can then print off a race pass 304 (step 405). Depending on the event, the race pass may contain a waiver and/or terms and conditions for attending the event that the participant is required to sign. Each printed race pass will display the unique identifier 305 allocated to that participant, for example the pass will be printed with a visible QR code or barcode.

Alternatively, the participant may complete the online check-in on a portable device, for example a mobile phone, laptop or tablet. In this case instead of printing off the race pass the participant could download an electronic copy of the pass including the unique identifier, i.e. the screen of the device would display the pass and the unique identifier, for example QR code or barcode.

When the participant arrives at the event he presents his printed race pass or portable device 304 to a member of event staff 306.

The event staff has access to a computer terminal 308. The computer terminal is installed with an application 312 that is capable of synchronising with the server 303. Thus some time before the event but after registration has closed, the application 312 on the terminal 308 is synchronised with the server via a network, for example the internet. Once synchronised, all the information on the server relating to the event, such as the profile database and database of unique identifiers, is held in a record on the computer terminal 308.

The staff scan the unique identifier on the participant's race pass (either by scanning the ticket or the screen of the portable device displaying the unique identifier) using a scanner 307 connected to a computer terminal 308. The unique code retrieved from the unique identifier is input into a processor 309 housed in the computer terminal 308. The processor is configured to recall from the record details of the participant's profile that are associated with that unique code. These details can then be presented on a display screen. The display screen can form part of the computer terminal or alternatively can be a separate screen connected to the terminal. For security purposes, the profile may contain a picture of the participant which event staff can view on the display screen to ensure the race pass holder is the registered participant.

The method of issuing an event pass in a manner as described with reference to FIG. 3 advantageously allows additional unique identifiers to be associated with a participant in minimal time once they are at the event.

Once the participant's unique identifier on their race pass has been scanned, the event staff may elect to associate further identifiers to the participant such as RFID tags and bib numbers (step 406). In order to do this, the event staff use a reader 311 connected to the computer terminal 308. The event staff then select a further unique identifier, for example an RFID tag, and use the reader 311 to read the unique information embedded in the identifier. This unique information is then input into the processor 309, which associates the information with the participant's profile stored in the record. Thus further unique identifiers are associated with the participant (step 407).

This advantageously means that any further unique identifier, i.e. any bib number or RFID tag, can be readily associated with any particular participant simply by reading the information embedded in the unique identifier. The unique identifier is associated with the participant by entering the information into the relevant entry of the database of unique identifiers. This advantageously allows the expedient association of a bib number and RFID tag to each participant on race day, negating the need to perform this association for every participant several days before hand.

In practice the process may work as follows: a member of event staff will select a bib number and/or RFID tag (randomly if they wish), use the reader to associate it to the participant's profile and then hand the bib and/or tag to the participant, who is then free to enter the event with additional unique identifiers. Thus it can be seen this method has the additional advantage of being far less susceptible to error than the prior art method due to the proximity in both time and location of the associations.

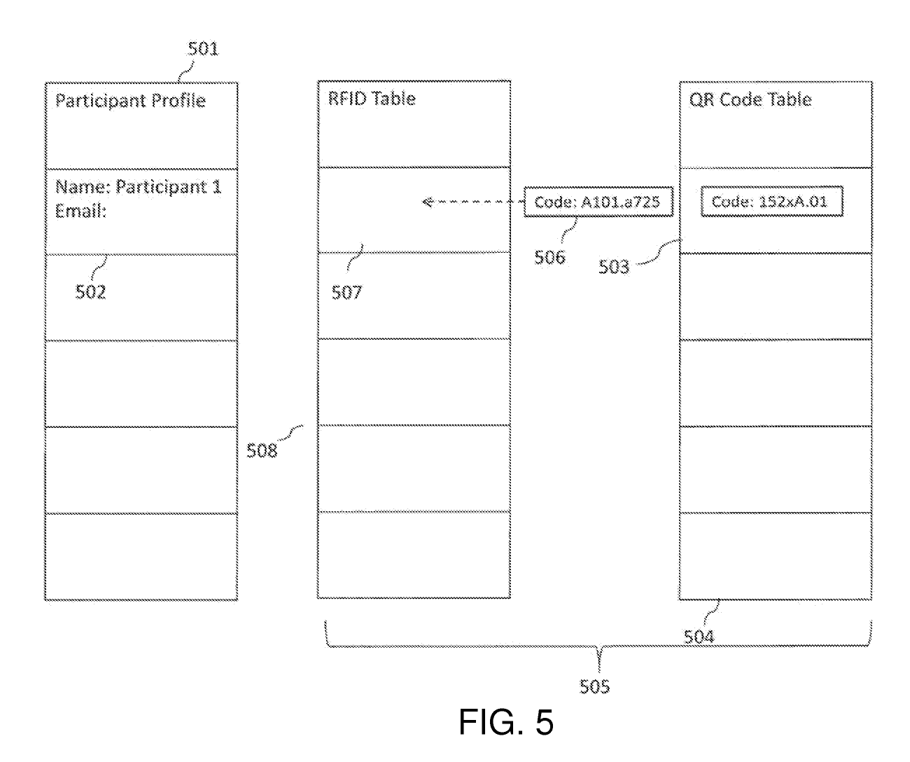

A schematic diagram of the databases during the association of further unique identifiers is shown in FIG. 5. Element 501 depicts the participant profile database which is populated as participants register for the event. Entry 502 contains the profile details of participant 1. When participant 1's profile was created a unique code was generated that was embedded into a QR code on participant 1's race pass. That unique code is stored in entry 503 of the QR code table 504 that forms part of the database of unique identifiers 505. Thus entry 503 is mapped or associated with entry 502. If a member of event staff elects to associate a further unique identifier with participant 1, for example an RFID tag, the reader 311 is used to obtain the code 506 embedded in the tag. The code 506 is then associated with participant 1 by being entered into an entry 507 of RFID table 508 stored in the record, where entry 507 is mapped or associated with entry 502.

In practice, an event such as a marathon would have multiple terminals 308. Each terminal could contain an application 312 that permits the terminal to be synchronised with the server 303. Thus sometime before the event, each terminal is synchronised with the server such that each terminal contains in a record all the information stored at the server relating to the event. This allows a participant to go to any terminal when they arrive at the event. Each of the terminals may be configured in a network such that the terminals can synchronise their records with each other as participants arrive at the event. This advantageously allows the record of each terminal to be updated without the need to connect to the server 303. This is beneficial as there may be intermittent or even no internet at certain events, meaning the terminals would not be able to connect to the server. Once an internet connection was again available, the terminals could synchronise with the server to update the databases stored at the server.

The terminal could be any suitable device capable of holding a record of databases and capable of connecting to a display screen, for example a laptop, tablet or other specialised hardware.

Alternatively, each terminal may not hold a record of the databases but may be configured to connect to the server 303. For example the terminals may be simple devices that do not have the memory for storing the databases in a record, but they may be operating in an environment with a stable internet connection. An example of such a terminal could be a mobile phone or other specialised hardware capable of connecting to a server and to a display screen but with limited memory. In this case there is no need to synchronise the terminals with the server before the event. Instead, each terminal would comprise a processor configured to communicate, via an interface 310, with the server 303.

So for example, when the event staff scans the unique identifier on the participant's race pass using scanner 307, the unique code retrieved from the unique identifier is input into the processor 309 housed in the computer terminal 308. The processor is configured to recall from a record on the server details of the participant's profile that are associated with that unique code. Similarly, when a further identifier is to be associated with a participant, the reader 311 is used to read the unique information embedded in the identifier. This unique information is then input into the processor 309, which is configured to transmit to the server, via interface 310, the unique information for association with the participant profile stored in the record.

An alternative embodiment of the present invention will now be described. In this embodiment, a participant registers for an event by completing an online registration in a similar manner to that described previously. That is, when a participant registers for an event online a profile is created for that participant and a unique code generated that is associated with that participant. The event organiser may wish to specify a mandatory amount of data that each participant is to provide in their profile in order to join the event. An option may also be presented to allow the participant to load credit to their profile (by using their bank/credit cards) to facilitate a cash-less system of purchasing items once they are at the event. This will be described in more detail below. The unique code could be embedded into a suitable unique identifier such as a QR code or barcode. To complete registration for the event the participant prints off an event pass that contains the unique identifier.

It is often the case that an event will host multiple suppliers who offer merchandise for sale. The merchandise could be, for example, food, beverages, apparel, programs or any suitable sale product. Often the suppliers are third parties who pay a fee to the event organiser for permission to sell their merchandise at the event, or they may pay a certain percentage of their sales to the organiser as part of their fee. It is often in both the merchandiser's and the event organiser's interest to know the popularity of each of the products offered for sale. For the event organiser, knowledge of which products are popular can be used to improve the participant's experience of the event, whilst a merchandiser would obviously be keen to tailor his future stock towards the more popular products.

By associating additional unique identifiers (i.e. beyond that of the identifier on the event pass) to participants at an event, it is possible to determine information relating to sales of merchandise, such as the demographics of sales and the popularity of products.

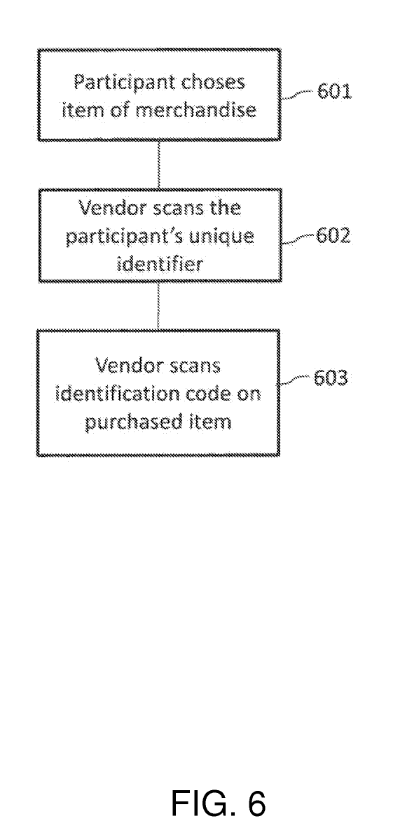

FIG. 6 describes the association of additional unique identifiers (i.e. beyond that of the identifier on the event pass) to a participant who is purchasing merchandise at an event. At step 601, a participant chooses an item of merchandise they wish to purchase from a vendor. Each item of merchandise could have a pre-applied identification code or tag, for example a QR code may be applied to each item. This could be done by the vendor before the event.

At step 602 the vendor scans the participant's unique identifier on their event pass. This could be done when the participant goes to purchase the item of merchandise. The scanner used by the vendors is similar to scanners 307 described with reference to FIG. 3. That is, the scanners are connected to a computer terminal that has access to a record containing the participant database and database of unique identifiers. Following the scan of the participant's user identifier, the vendor then scans the identification code on the item being purchased (step 603). The code is then communicated to the record containing the database of unique identifiers and entered into the database for association with the participant. This then associates the item being purchased to the participant by associating that item with the participant's profile.

The vendor could be employed directly by the event organiser or could be a third party supplier as described above. In the event that the vendor is a third party supplier, the scanning equipment can be lent to them by the event organiser. This allows the scanners used by the vendors to be networked to the participant profile database in order to allow the association of their items of merchandise with the participant. The third party suppliers can be entered into a separate database which details which equipment has been lent to which supplier.

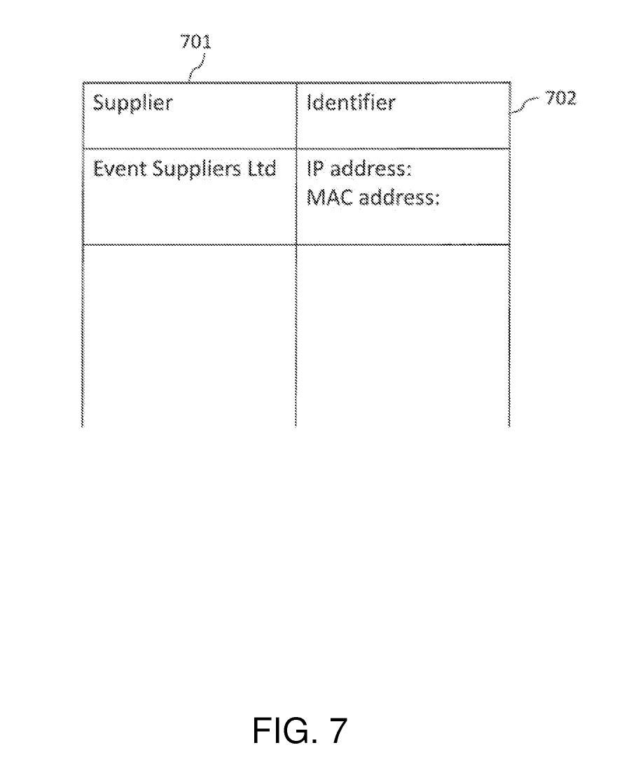

FIG. 7 is a schematic diagram of a database containing third party suppliers. Column 701 contains the name of each supplier at a particular event and column 702 contains identifiers of the scanning equipment being used by the suppliers. In this example, the identifier for the equipment is the IP address and MAC address, although it should be appreciated that any unique identifier could be used, for example each piece of equipment could be fitted with an RFID tag.

By associating each item of sold merchandise to a participant, the supplier can track who they sold what item to. This information could be gathered from the event organiser (who has access to the participant profile database) after the event. As each item is associated with the participant's profile, the supplier can use this information to build a picture of the demographics of sales for each particular item. In order to encourage participants to have the unique identifiers on their event pass scanned, the suppliers could offer discounts and incentives to participants who present their unique identifier. Such information can also be used by the event organizer to determine the popularity of the suppliers and of particular merchandise.

At certain events not desirable to carry around cash and or bank cards for fear of theft or loss. If a participant loaded credit into their profile during registration, this credit can be used to purchase merchandise when at the event. The participant could present a unique identifier and possible a second factor of authentication, such as ID. It may be preferable to use a more secure identifier to validate purchases, such as an RFID tag or biometric. These identifiers could be associated with the participant when they arrive at the event in a manner described above.

By having readers situated around the venue of an event that are capable of reading the information embedded in a unique identifier, it is possible for an event organiser to gather real-time data on the locations of participants for the purpose of crowd management. The unique identifiers could be, for example RFID tags, which are capable of being read up to a range extending several mets. For example, an organiser could determine the number of participants currently in a particular area of the event and respond by closing off certain areas and diverting participants. This could prevent bottlenecks and in severe cases crushes.

The applicant hereby discloses in isolation and combination each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of such features. In view of the foregoing description it will be evident to a person skilled in the art that various modifications can be made within the scope of the invention.

What is claimed is:

1. A computer system for associating identifiers to identified participants, the system comprising:
a computer terminal having access to a record stored in a database holding participant data for an event at an event location, the computer terminal comprising a processor;
a first input means connected to the computer terminal and operable at the event location to receive a participant identifier, the participant identifier generated for and unique to the participant and associated with participant data in the record, the processor configured to recall from the record participant data associated with the participant identifier; and
a second input means connected to the computer terminal and operable at the event location to receive a further unique identifier, the processor configured to receive the further unique identifier and transmit it to the record for association with the participant data in the record.

2. A computer system as claimed in claim 1, wherein the computer terminal comprises a display for displaying user data to a terminal operator for authenticating identity of the participant.

3. A computer system as claimed in claim 1, wherein the computer terminal comprises a network interface for connection to a server.

4. A computer system as claimed in claim 3, comprising a server connected to the network interface and configured to receive the participant identifier and to transmit the participant data to the computer terminal.

5. A computer system as claimed in claim 4, wherein the server is configured to receive the further unique identifier and associate said further unique identifier with the participant data in the record.

6. A computer system as claimed in claim 3, comprising a participant terminal having a network interface for connection to the server and arranged to receive participant data from a participant, to transmit the participant data to the server and to receive a unique participant identifier based on the participant data.

7. A computer system as claimed in claim 6, wherein the unique participant identifier is in the form of a code, Quick response code, barcode or data string.

8. A computer system as claimed in claim 1, wherein the first input means comprises a barcode reader or QR reader.

9. A computer system as claimed in claim 1, wherein the second input means comprises an RFID reader, GPS reader, barcode reader or QR reader.

10. A computer system as set forth in claim 1, wherein said further unique identifier comprises a device identifier.

11. A computer system as set forth in claim 10, wherein said device comprises an RFID tag.

12. A computer system as set forth in claim 1, wherein said further unique identifier comprises a participant bib number.

13. A competitive event tag allocation apparatus comprising:
a computer system as claimed in claim 1; and
a plurality of physical tags to be worn by participants in the event, each tag having a unique device identifier, wherein a tag is provided to a participant when its device identifier has been associated with the participant data.

14. An apparatus as claimed in claim 13, wherein the tags are RFID tags.

15. An apparatus as claimed in claim 13 comprising multiple computer terminals at one or more locations at an event venue.

16. A vendor apparatus comprising:
a computer system as claimed in claim 1; and
a plurality of vendor products each having a unique device identifier, wherein a vendor product is provided to a participant when its device identifier has been associated with the participant data.

17. A vendor apparatus as claimed in claim 16, wherein each vendor product is marked with its device identifier for automated receipt by the second input means.

18. An event server comprising:
a processor;
a memory holding a plurality of participants' records, the records comprising participant data for each participant;
an interface for connecting the server to at least one participant terminal and a computer terminal, the processor configured to:
receive a participant identifier generated for and unique to a participant and transmit participant data associated with the participant identifier; and
receive a further unique identifier and associate the further unique identifier with the participant data in the record.

19. An event server as claimed in claim 18, wherein said further unique identifier comprises a device identifier.

20. An event server as claimed in claim 19, wherein said device comprises an RFID tag

21. A method comprising:
receiving at first input means connected to a computer terminal at an event location a participant identifier for an event, the participant identifier generated for and unique to the participant and associated with participant data in a record accessible by the computer terminal, the record stored in a database holding participant data for the event;
recalling from the record participant data associated with the participant identifier;
receiving at second input means connected to the computer terminal at the event location a further unique identifier; and
transmitting the further unique identifier to the record for association with the participant data in the record.
